(19) United States
(12) Patent Application Publication
(10) Pub. No.: US 2024/0250888 A1
(43) Pub. Date: Jul. 25, 2024

(54) METHODS AND SYSTEMS FOR DELIVERING TELEMETRY DATA

(71) Applicant: Comcast Cable Communications, LLC, Philadelphia, PA (US)

(72) Inventors: Robert Deen, Universal City, CA (US); James Ehlinger, Universal City, CA (US)

(21) Appl. No.: 18/157,330

(22) Filed: Jan. 20, 2023

(51) Int. Cl. H04L 43/08; H04L 45/00

(52) U.S. Cl. CPC H04L 43/08; H04L 45/70

(57) ABSTRACT

Methods, apparatuses, and systems are described for determining one or more characteristics of a network using multiplexed network transport protocols. A device may inject data into the network and send information indicative of the data injected into the network. A network device may receive the information indicative of the data injected into the network, monitor the network to identify the data injected into the network, and determine one or more characteristics of the network.

### BACKGROUND

Delivering streamed video over the Internet requires the ability to acquire accurate data associated with network delivery capabilities during the streaming of video and other data. This often involves the use of a third party observer to monitor network data packets. However, the increased pervasive incorporation of packet encryption and changes to Internet transport protocol packet designs have continuously removed most observable data from the transport protocol packets. For example, the new IETF QUIC protocol provides the use of only a single bit assigned for end-to-end delivery testing and observation with all other transport header data encrypted. This creates new challenges for determining range and quality telemetry data for data streams at the network level due to the increased focus on encrypting network data flows.

### SUMMARY

It is to be understood that both the following general description and the following detailed description are exemplary and explanatory only and are not restrictive. Methods, systems, and apparatuses for improved content streaming are described.

A device (e.g., a network device, a user device, etc.) connected to a network may initiate an Internet connection with other devices over one or more networks. The device may inject data into a network and send attribute data of the injected data to a second device. The network may be monitored by a second device for an effect caused by the injected data. The second device may compare the attributes of the injected data and the effect caused by the injected data to identify the injected data and thereby determine one or more characteristics of the network.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for injecting data into a network;

FIG. 2 shows an example network;

FIGS. 3A-3C show example data that may be injected into the network;

FIG. 4 shows an example pulse signal;

FIGS. 5A-5C show an example effect of the injected data on the network;

FIG. 6 shows an example data flow scenario of the data packets;

FIG. 7 shows a flowchart of an example method;

FIG. 8 shows a flowchart of another example method;

FIG. 9 shows a flowchart of another example method;

FIG. 10 shows a flowchart of another example method;

FIG. 11 shows a flowchart of another example method; and

FIG. 12 shows a block diagram of an example system and computing device.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

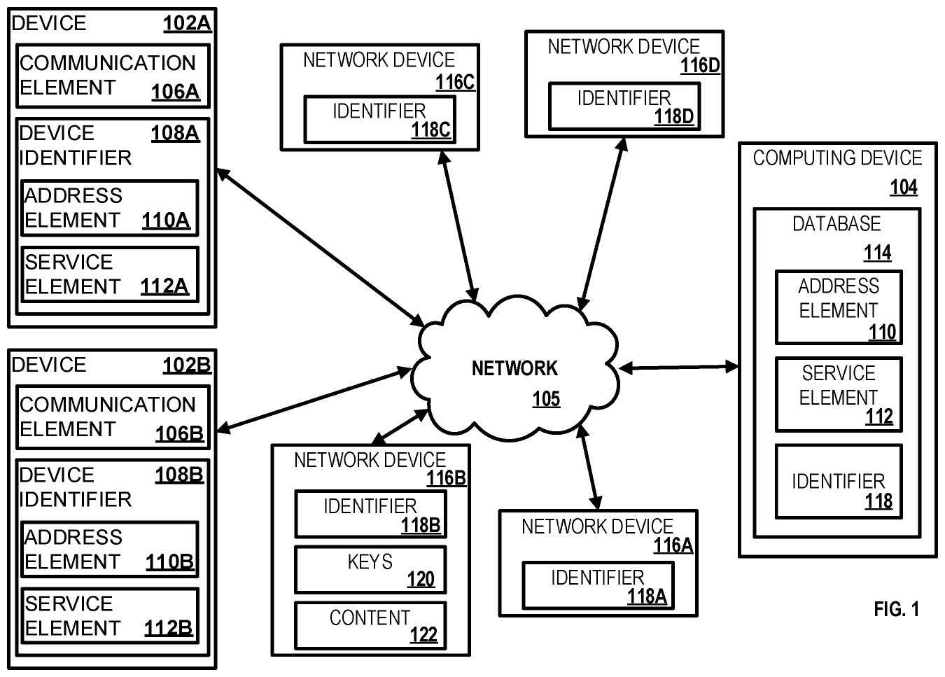

FIG. 1 shows an example system 100 for injecting data (e.g., one or more pulse signals) into a network. For example, the system 100 may be configured to inject data into a network 105 and send information indicative of the injected data to a device (e.g., devices 102A-102B, network devices 116A-116D, computing device 104, etc.) connected to the network 105. The system 100 may be configured to provide services, such as network-related services, to a device. The network and system may comprise a plurality of devices 102A-102B in communication with a plurality of network devices 116A-116D and/or a computing device 104, such as a server, for example, via network 105. The computing device 104 may be disposed locally or remotely relative to the devices 102A-102B and the network devices 116A-116D. As an example, the devices 102A-102B, network devices 116A-116D, and the computing device 104 can be in communication via a private and/or public network 105 such as the Internet or a local area network (LAN). Other forms of communications can be used such as wired and wireless telecommunication channels, for example.

The devices 102A-102B may comprise one or more user devices. The user devices may comprise electronic devices such as computers, smartphones, laptops, tablets, set top boxes, display devices, or other devices capable of communicating with the network devices 116A-116D and/or the computing device 104.The user devices may further comprise devices such as media devices, VoIP devices, routers, printers, WiFi speakers, security cameras, or smart assistant devices (e.g. Alexa, Nest, Ring, etc.). As an example, the devices 102A-102B may comprise communication elements 106A-106B for providing an interface to a user to interact with the devices 102A-102B and/or the computing device 104. The communication elements 106A-106B can be any interface for presenting and/or receiving information to/from the user, such as user feedback. An example interface may be a communication interface such as a web browser (e.g., Internet Explorer®, Mozilla Firefox®, Google Chrome®, Safari®, or the like). Other software, hardware, and/or interfaces can be used to provide communication between the user and one or more of the devices 102A-102B and the network devices 116A-116D and/or the computing device 104. As an example, the communication elements 106A-106B may request or query various files from a local source and/or a remote source. As an example, the communication elements 106A-106B may transmit data to a local or remote device such as the network devices 116A-116D and/or the computing device 104.

The devices 102A-102B may be associated with user identifiers or device identifiers 108A-108. As an example, the device identifiers 108A-108B may be any identifier, token, character, string, or the like, for differentiating one user or user device (e.g., devices 102A-102B) from another user or user device. As an example, the device identifiers 108A-108B may identify a user or user device as belonging to a particular class of users or user devices. As an example, the device identifiers 108A-108B may comprise information relating to the devices 102A-102B such as a manufacturer, a model or type of device, a service provider associated with the devices 102A-102B, a state of the devices 102A-102B, a locator, and/or a label or classifier. Other information can be represented by the device identifiers 108A-108B.

The device identifiers 108A-108B may comprise address element 110A-110B and service element 112A-112B. The address elements 110A-110B may comprise or provide an Internet protocol address, a network address, a media access control (MAC) address, international mobile equipment identity (IMEI) number, international portable equipment identity (IPEI) number, an Internet address, or the like. As an example, the address elements 110A-110B may be relied upon to establish a communication session between the devices 102A-102B and the network devices 116A-116D and/or the computing device 104 or other devices and/or networks. As an example, the address elements 110A-110B can be used as an identifier or locator of the devices 102A-102B. In an aspect, the address elements 110A-110B can be persistent for a particular network.

The service elements 112A-112B may comprise an identification of the service providers associated with the devices 102A-102B, with the class of devices 102A-102B, and/or with a particular network 105 with which the devices 102A-102B are currently accessing services associated with the service providers. The class of the devices 102A-102B may be related to a type of device, capability of device, type of service being provided, and/or a level of service (e.g., business class, service tier, service package, etc.). As an example, the service elements 112A-112B may comprise information relating to or provided by a communication service provider (e.g., Internet service provider) that is providing or enabling data flow such as communication services to the devices 102A-102B. As an example, the service elements 112A-112B may comprise information relating to a preferred service provider for one or more particular services relating to the devices 102A-102B. In an aspect, the address elements 110A-110B can be used to identify or retrieve data from the service elements 112A-112B, or vice versa. As an example, one or more of the address elements 110A-110B and the service elements 112A-112B may be stored remotely from the devices 102A-102B and retrieved by one or more devices such as the devices 102A-102B and the computing device 104. Other information may be represented by the service elements 112A-112B.

The computing device 104 may comprise a server for communicating with the devices 102A-102B and/or the network devices 116A-116D via network 105. As an example, the computing device 104 may communicate with the devices 102A-102B for providing data and/or services. As an example, the computing device 104 may provide services, such as network (e.g., Internet) connectivity, network printing, media management (e.g., media server), content services, streaming services, broadband services, or other network-related services. The computing device 104 may allow the devices 102A-102B to interact with remote resources, such as data, devices, and files. As an example, the computing device 104 may be configured as (or disposed at) a central location (e.g., a headend, or processing facility), which may receive content (e.g., data, input programming) from multiple sources. The computing device 104 may combine the content from the multiple sources and may distribute the content to user (e.g., subscriber) locations via a distribution system.

The computing device 104 may be configured to manage the communication between the devices 102A-102B and a database 114 for sending and receiving data therebetween. As an example, the database 114 may store a plurality of files (e.g., web pages), user identifiers or records, or other information. As an example, the devices 102A-102B may request and/or retrieve a file from the database 114. The database 114 may store information relating to the devices 102A-102B such as the address element 110 and/or the service element 112. As an example, the computing device 104 may obtain the device identifiers 108A-108B from the devices 102A-102B and retrieve information from the database 114 such as the address elements 110A-110B and/or the service elements 112A-112B. As an example, the computing device 104 may obtain the address elements 110A-110B from the devices 102A-102B and may retrieve the service elements 112A-112B from the database 114, or vice versa. Any information may be stored in and retrieved from the database 114. The database 114 may be disposed remotely from the computing device 104 and accessed via direct or indirect connection. The database 114 may be integrated with the computing device 104 or some other device or system.

One or more of the network devices 116A-116D may be configured to facilitate the connection of a device, such as the user device 102A-102B, to the network 105. As a further example, the network devices 116A-116D may be configured as wireless access points (WAPs). The network devices 116A-116D may be configured to allow one or more wireless devices to connect to a wired and/or wireless network using Wi-Fi, Bluetooth®, Zigbee®, or any desired method or standard.

The network devices 116A-116D may comprise identifiers 118A-118D. As an example, one or more identifiers can be or relate to an Internet Protocol (IP) Address IPV4/IPV6 or a media access control address (MAC address) or the like. As an example, the identifiers 118A-118D may be unique identifiers for facilitating communications on the physical network segment. Each of the network devices 116A-116D may comprise an identifier 118 that is distinct. As an example, the identifiers 118A-118D may be associated with a physical location of the network devices 116A-116D.

One or more devices (e.g., devices 102A-102B, network devices 116A-116D, the computing devices 104, etc.) may be configured to establish a network connection with at least one other device (e.g., devices 102A-102B, network devices 116A-116D, the computing devices 104, etc.) via network 105. The network connection may comprise an Internet connection comprising a plurality of independent data streams. For example, each independent data stream may comprise a plurality of data packets, wherein each data packet may be individually encrypted. The plurality of independent data streams may comprise one or more of data injected into the network, one or more media streams, one or more video streams, one or more audio streams, one or more data streams, or any combination thereof. The network connection may comprise an encrypted connection such as a Quick UDP Internet Connection (QUIC) connection, wherein each data packet of the plurality data packets may be individually encrypted. However, the use of such encryption methods as QUIC increases the difficulty for third party monitoring of the data packets. For example, the QUIC protocol provides the use of only a single bit assigned for end-to-end delivery testing and observation, wherein all other transport header data is encrypted.

Thus, the devices connected to the network 105 may be configured to inject data (e.g., a pulse signal) into the network 105 and send information indicative of the injected data to a monitoring device to enable the monitoring device to determine one or more characteristics of the network. For example, the data injected into the network may be used in order to track one or more data packets of the plurality of individually encrypted data packets as the one or more data packets are transmitted throughout the network 105. The monitoring device may determine one or more characteristics of the network by correlating the information indicative of the injected data with an effect caused to the network by the injected data. For example, unencrypted data injected into the network may result in one or more of the plurality of individually encrypted data packets to increase in a data size. The monitoring device may identify a pattern of the plurality of individually encrypted data packets based on the information indicative of the injected data. For example, the monitoring device may determine that the data size of one or more of the plurality of individually encrypted data packets appear in the network according to a particular signal pattern (e.g., pulse signal according to one or more attributes) and correlates with the information indicative of the injected data. Thus, the monitoring device may identify the data injected into the network based on the correlation of the information indicative of the injected data with the effect caused to the network by the injected data. Based on the identification of the data injected into the network, the monitoring device may determine the one or more characteristics of the network. The one or more characteristics of the network may comprise one or more of a network backlog, network congestion, or data packet loss. In an example, the injected data may comprise null data packets that may be injected into the network as a pulse signal comprising one or more attributes. The one or more attributes may comprise one or more of a predetermined data size, a predetermined data frequency, a predetermined data pattern, a random data pattern, or a predetermined data injection interval. In an example, the monitoring device may analyze the network based on identifying the injected data to determine one or more characteristics of the network over a period of time. The monitoring device may determine one or more characteristics of the network during one or more time segments and correlate the one or more characteristics during each time segment of the one or more time segments to determine how the network behaves and varies over time. The one or more time segments may comprise one or more of one or more contiguous time segments, one or more continuous time segments, or one or more discrete time segments. As an example, the devices 102A-102B, the network devices 116A-116D, the computing devices 104, or any combination thereof, may be configured to inject the data into the network and send the information indicative of the injected data to the monitoring device. As an example, the devices 102A-102B, the network devices 116A-116D, the computing devices 104, or any combination thereof, may be configured to act as a monitoring device and receive the information indicative of the injected data to determine the one or more characteristics of the network.

As an example, the one or more characteristics of the network may be used to determine that one of the independent data streams of the network has reached a point in the network that is subject to network congestion or is experiencing data packet loss between two points of the network. For example, a network connection may be established between device 102A and device 102B, wherein at least one independent data stream of the plurality of independent data streams may be routed via network device 116A. Device 102B may determine, based on identifying data injected into the network by device 102A, that network device 116A is experiencing congestion. In response, device 102B may communicate the network issue to device 102A, wherein device 102A may cause the at least one independent data stream to re-route via network device 116B to device 102B. Device 102A, for example, may further inject data into the data stream directed towards device 102B for device 102B to determine/confirm that there are no issues (e.g., network backlog, network congestion, or data packet loss) with routing the at least one independent data stream via network device 116B.

As an example, two devices (e.g., devices 102A-102B, network devices 116A-116D, computing device 104, etc.) may communicate bi-directionally between each other via the network (e.g., QUIC connection, Internet connection). For example, device 102A may inject data into the network to communicate one or more characteristics associated with the network to device 102B. Device 102B may provide a communication, in response to the injected data, by injecting data of its own into the network directed towards device 102A.

As an example, a device (e.g., devices 102A-102B, network devices 116A-116D, computing device 104, etc.) monitoring the network may identify the data injected into the network to determine one or more characteristics of at least one independent data stream of the plurality of independent data streams of the network. For example, the monitoring device may “subtract” the signature of the injected data from the collected telemetry of a network connection (e.g., the total amount of data of the network connection) to determine the one or more characteristics of the at least one independent data stream. The one or more characteristics of the at least one independent data stream may comprise one or more of a bit rate of the at least one independent data stream or a bandwidth requirement of the at least one independent data stream.

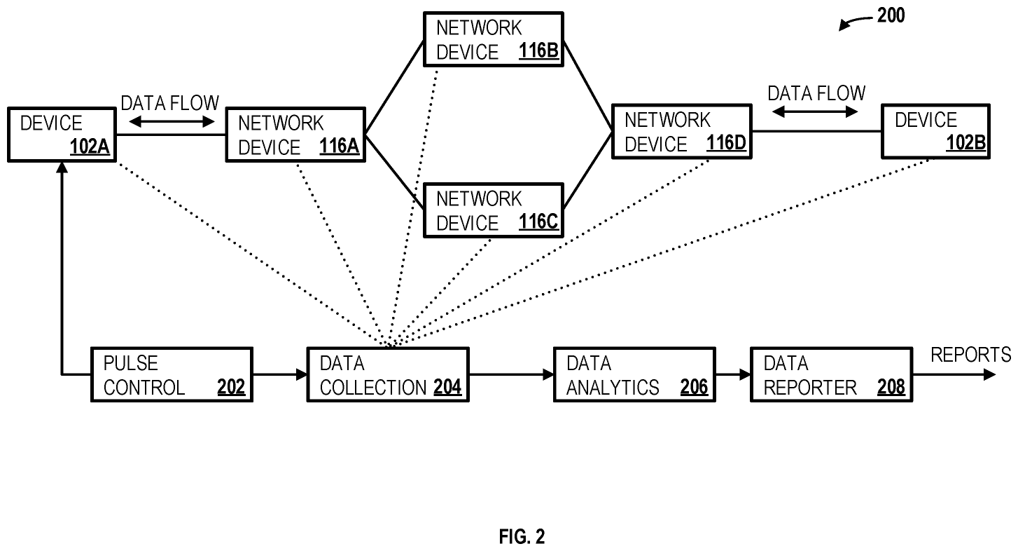

FIG. 2 shows an example network 200 for the data flow of the data packets in the network 200 between the two devices. For example, device 102A may establish a network connection with device 102B. The network connection may comprise a plurality of independent data streams. Each independent data stream of the plurality of independent data streams may comprise a plurality of data packets. The plurality of independent data streams may comprise one or more of data injected into the network, one or more media streams, one or more video streams, one or more audio streams, one or more data streams, or any combination thereof. The network connection may comprise an encrypted connection, such as a QUIC connection, wherein each data packet of the plurality of data packets may be individually encrypted, and thus, increasing the difficulty for third party monitoring of the data packets. As an example, as shown in FIG. 2, device 102A may establish a network connection wherein at least some of the data packets of at least one of the independent data streams may be routed via network device 116A, network device 116B, and network device 116D before reaching device 102B. Furthermore, at least some of the data packets of at least one other independent data stream may be routed via network device 116A, network device 116C, and network device 116D before reaching device 102B. Devices 102A and 102B may be configured to communicate one or more characteristics of the network connection to each other by injecting data (e.g., pulse signal) into the network connection and sending information indicative of the injected data to each other to enable the other device to determine the one or more characteristics of the network connection.

In an example, a pulse control device 202 may be configured to cause at least one of the devices 102A-102B to inject data into the network connection. The pulse control device 202 may be configured to create and manage data events that will create the data to be injected into the network connection. The pulse control device 202 may be configured to define a new pulse event and pulse data wave form, set the pulse event data size, set the pulse event data content, create a new pulse event queue, create the pulse event instance, add the pulse event instance to the signal queue scheduled for a time X, process the pulse event queue, stop the pulse event queue, and get the pulse event history report. A data collection device 204 may be configured to receive information indicative of the injected data from the pulse control device 202 so that the data collection device 204 may identify the injected data (e.g., pulse signal). The data collection device 204 may be configured as one or more monitoring devices at different collection points in the network, such as the dotted lines shown in FIG. 2, for example. The data collection device 204 may be configured to send the injected data characteristics (e.g., time, data events, etc.) to a data analytics device 206 to permit the data analytics device 206 to identify the injected data and remove the injected data's signature from the collected telemetry of the network connection to permit analysis of the network data without the injected data. For example, by removing the injected data's signature, the data analytics device 206 may determine a bit rate of one or more of the data streams of the network connection. A data reporter 208 may then report the one or more characteristics of the network connection determined by the data analytics device 206 to device 102A and/or device 102B. The use of a pulse control device 202, a data collection device 204, a data analytics device 206, and a data reporter device 208 as separate devices is merely one example of injecting data into the network connection to determine one or more characteristics of the network connection. The devices may be combined into a single device, or the processes performed by each device may be performed by each of the devices 102A-102B and the network devices 116A-116D individually, or a combination thereof.

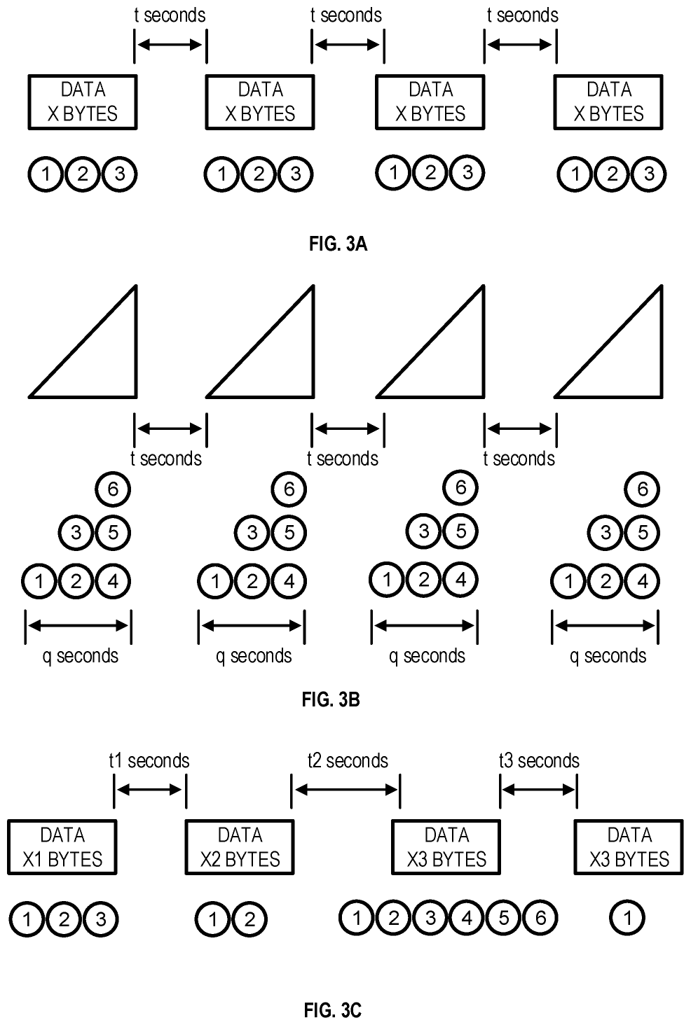

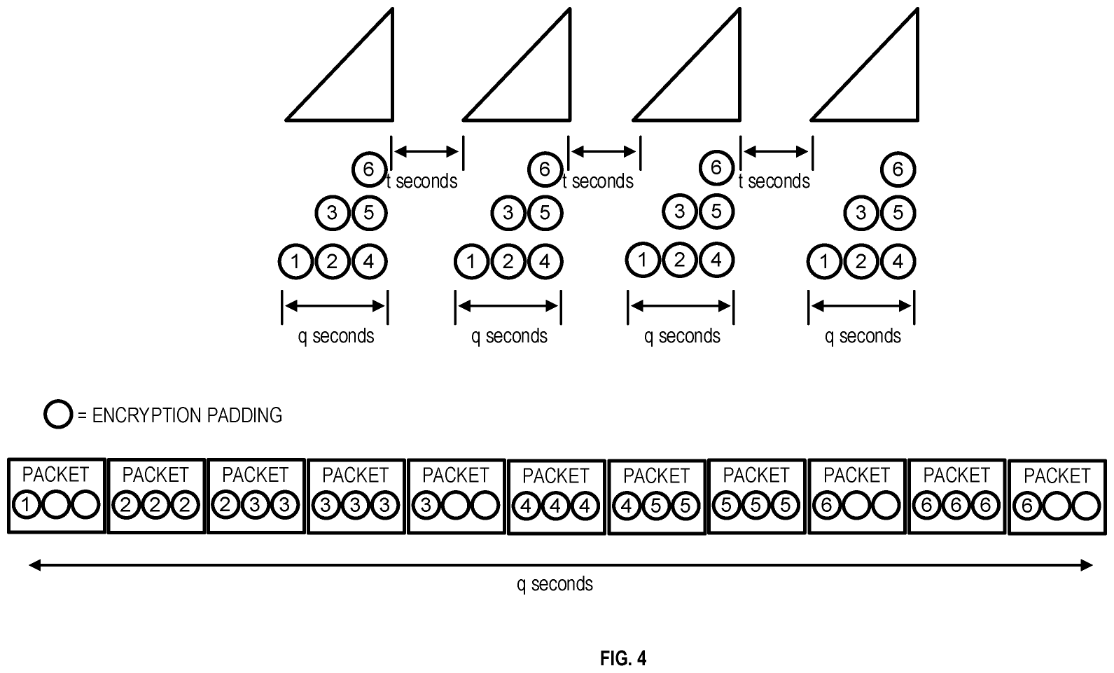

FIGS. 3A-C and FIG. 4 show example data that may be injected into the network connection. The injected data may comprise null data packets that may be injected into the network as a pulse signal comprising one or more attributes. The one or more attributes may comprise one or more of a predetermined data size, a predetermined data frequency, predetermined data pattern, a random data pattern, or a predetermined data injection interval. For example, FIG. 3A shows a signal containing fixed data amounts X bytes sent at fixed time t intervals. As an example, FIG. 3B shows a saw tooth signal, wherein data may start at one byte and increase at y bytes per second fraction for q seconds repeated every t seconds. As an example, FIG. 3C shows a signal containing random bytes at random intervals. The actual random data amounts and delays may be reported out to the telemetry system (e.g., devices 102A-102B, network devices 116A-116D, computing device 104, etc.) so that they may be identified in the collected telemetry data. This also permits them to be processed out of the collected raw telemetry of the network connection. FIG. 4 shows an example of a saw tooth signal as it may be encrypted in a QUIC network connection. The use of such encryption methods as QUIC increases the difficulty for third party monitoring of the data packets. Because the actual network packets are padded and encrypted to make observation difficult, pulses having varying data amounts over time increase the likelihood to detect the pulse signal, and thus, allowing third party monitoring of individually encrypted data packets. The use of data based on a repeatable pattern increases the chances of detection by a device monitoring the QUIC network connection. For example, over time the monitoring may recognize a QUIC connection has been injected with data by recognizing the pattern of the injected data. For example, the monitoring device may receive information indicative of the injected data and identify an effect cause by the injected data to the QUIC network connection. The monitoring device may identify a data waveform or pattern of the QUIC network connection that may be correlated with the information indicative of the data that was injected into the QUIC network connection. Based on correlating the waveform or pattern of the QUIC network connection with the information indicative of the injected data, the monitoring device may identify the injected data.

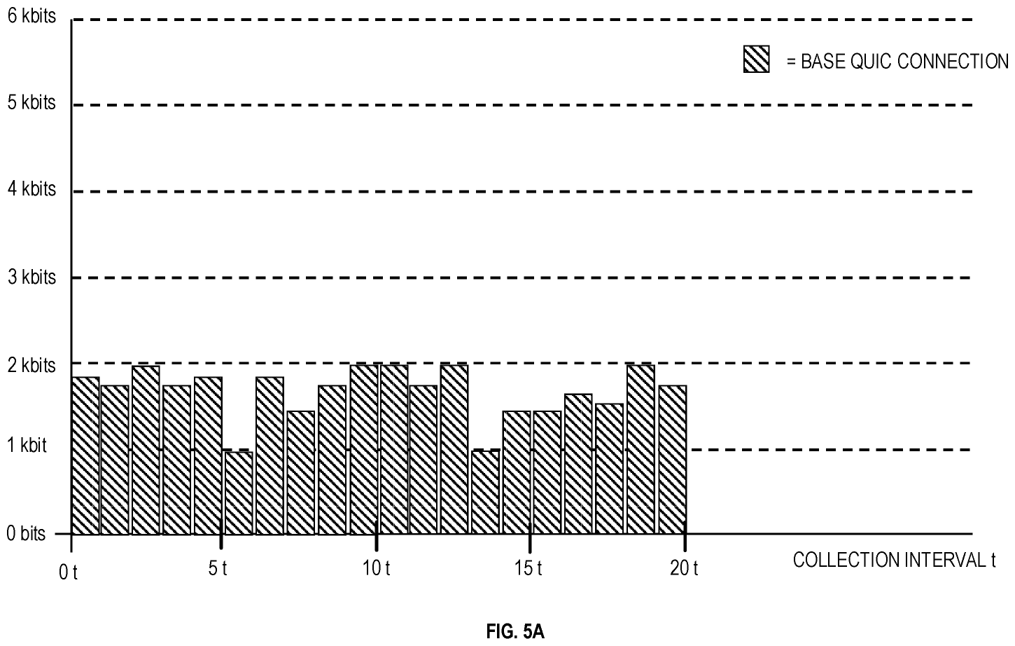

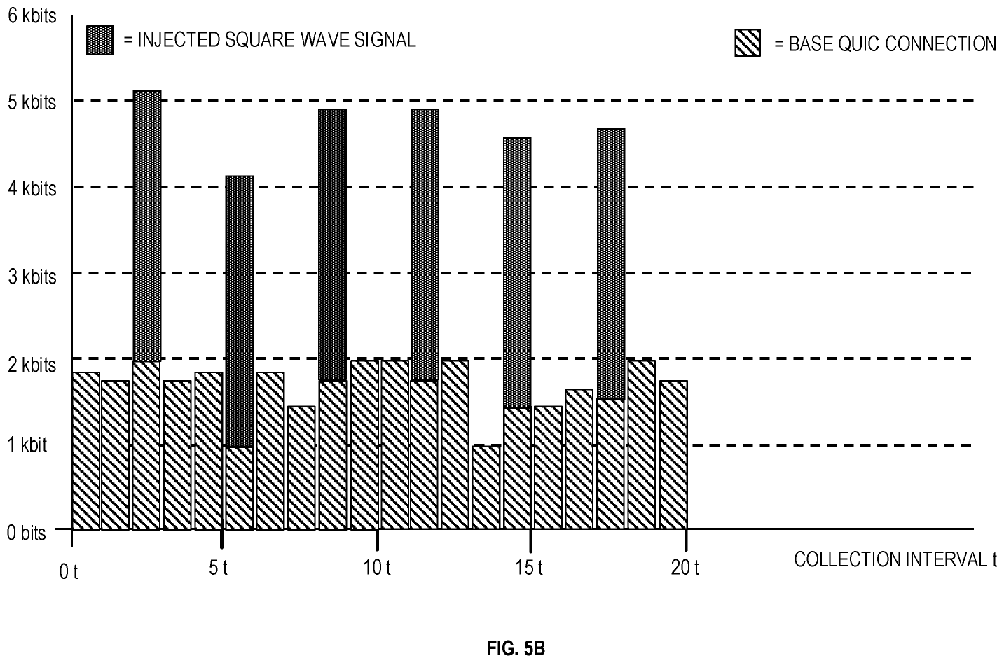

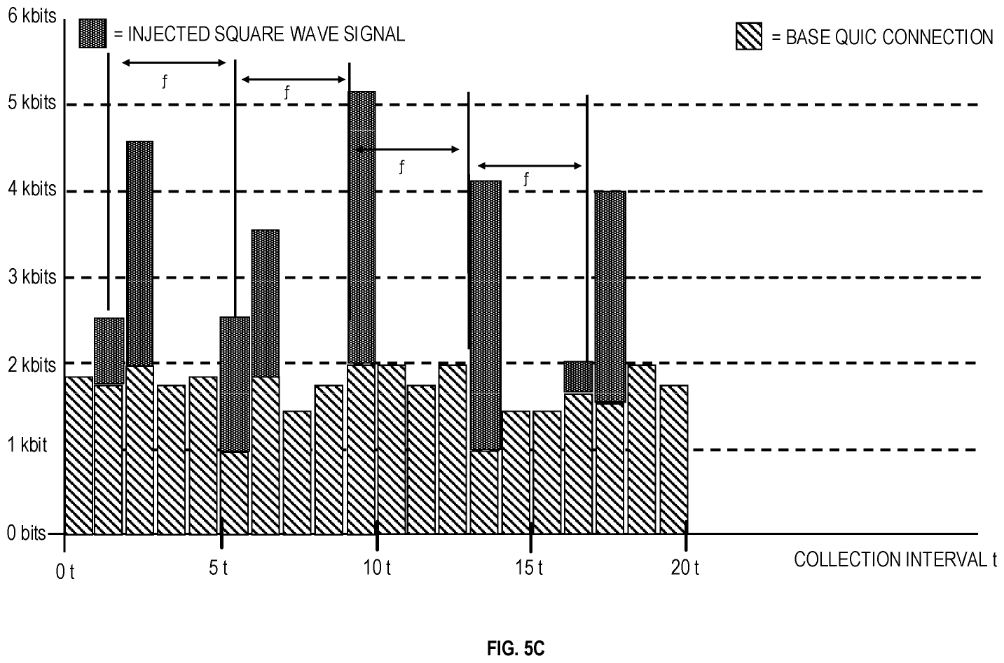

FIGS. 5A-5C show an example of how the injected data may affect the network connection at several data collection points. FIG. 5A, shows an example network connection that is monitored according to collection interval t. For example, a monitoring device may observe the network connection at multiple intervals, wherein the network connection never exceeds 2 kbits at each monitoring interval. As shown in FIG. 5B, data may be injected into the network connection. The injected data may comprise a square wave signal comprising 3.1 kbits at a frequency of 3t. As shown in FIG. 5C, a monitoring device may identify the injected data based on observing the irregularities in the network connection. Over time, the monitoring device may recognize the injected data based on the waveform or pattern of the injected data. For example, the square wave may be injected at a frequency f, wherein f/t comprises a non-whole number. Since frequency f may not be an even multiple of t, the injected signal may span multiple collection intervals. Thus, the injected signal/data, over time, may be distinctly recognizable by a device monitoring the network connection. The monitoring device may be configured to receive information indicative of the injected data. For example, the monitoring device may receive information indicating that the injected data comprises a square wave signal comprising 3.1 kbits at the frequency f. The monitoring device may determine, over time, an effect caused to the network connection based on the information indicative of the injected data. For example, the monitoring device may detect the pattern of the data peaks of the network connection at each data collection time t and determine that the network connection includes injected data. The monitoring device may correlate the effect caused to the network connection by the injected data with the information indicative of the injected data to identify the injected data. In an example, after identifying the injected data, the monitoring device may remove the injected data's signature from the collected telemetry of the network connection to analyze the network data without the injected data. For example, by removing the injected data's signature, the monitoring device may determine a bit rate of one or more of the data streams of the network connection.

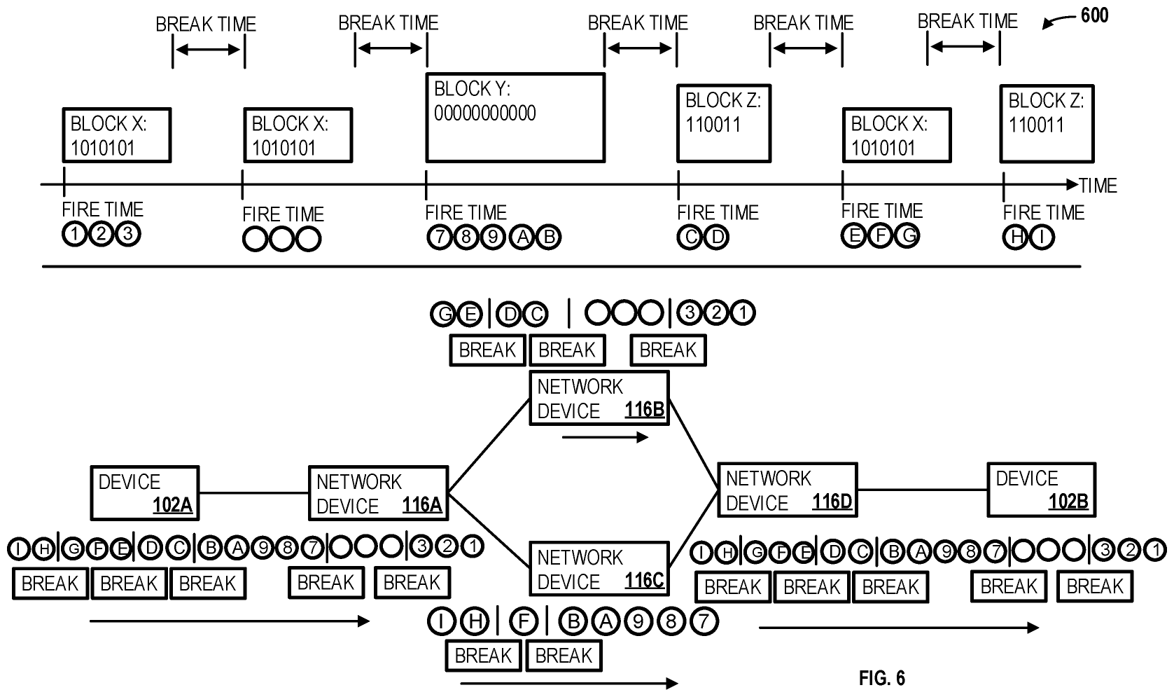

FIG. 6 shows an example data flow scenario 600 of the data packets in a network connection. In FIG. 6, device 102A may establish a network connection with device 102B. The network connection may comprise a plurality of independent data streams, wherein each independent data stream of the plurality of independent data streams may comprise a plurality of data packets. The network connection may comprise an encrypted connection, such as a QUIC connection, wherein each data packet of the plurality of data packets may be individually encrypted. The encryption of each data packet increases the difficulty for third party monitoring of the data packets. For example, FIG. 6 shows that data packets 1, 2, and 3 associated with Block X are sent at a first time, encryption data packets associated with Block X are sent at a second time, data packets 7, 8, 9, A, and B associated with Block Y are sent at a third time, data packets C and D associated with Block Z are sent at a fourth time, data packets E, F, and G associated with Block X are sent at a fifth time, and data packets H and I associated with Block Z are sent at a sixth time. Device 102A may establish a network connection wherein at least some of the data packets may be routed via network device 116A, network device 116B, and network device 116D, while at least some of the data packets may be routed via network device 116A, network device 116C, and network device 116D. For example, in FIG. 5, data packets G, E, D, C, 3, 2, and 1 and the encryption padding data packets are routed via network device 116B, while data packets I, H, F, B, A, 9, 8, and 7 are routed via network device 116C.

As an example, if network device 116B is experiencing any issues causing loss of data packets or network backlog/congestion, due to the use of an encrypted QUIC connection, device 102B would have difficulty detecting these issues. Device 102A may inject data into the network connection and send information indicative of the injected data to device 102B, wherein device 102B may identify the injected data, based on the information indicative of the injected data, to determine that network device 116B is the point in the network connection experiencing issues causing data packet loss or network backlog/congestion. As a result, device 102B may communicate this issue to device 102A, wherein device 102A may cause the data packets to be re-routed via network device 116C to device 102B. In an example, a monitoring device may monitor the data routed via network device 116B, identify the injected data, based on the information indicative of the injected data, and determine the issues associated with network device 116B and report the issues to device 102A.

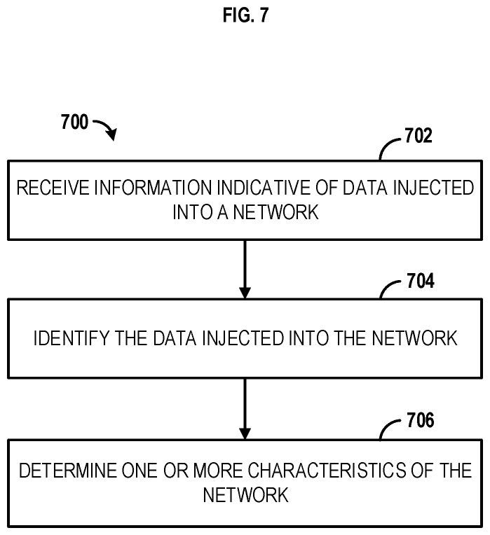

FIG. 7 shows an example method 700 for determining one or more characteristics of a network based on data injected into the network. Method 700 may be implemented by devices 102A-102B, network devices 116A-116D, computing device 104, or any combination thereof. At step 702, information indicative of data injected into a network may be received. The injected data may comprise a pulse signal having one or more attributes. The one or more attributes may comprise one or more of a predetermined data size, a predetermined data frequency, a predetermined data pattern, a random data pattern, a predetermined data injection interval, or any combination thereof. The information indicative of the injected data may comprise the one or more attributes of the injected data. The network may comprise a plurality of data streams associated with a plurality of individually encrypted data packets. The plurality of data streams may comprise one or more of the injected data, one or more media streams, one or more video streams, one or more audio streams, or one or more data streams.

At step 704, the injected data may be identified based on a correlation of the information indicative of the injected data with an effect caused to the network by the injected data. For example, the initial data injected into the network may comprise unencrypted data. The unencrypted data injected into the network may result in one or more of the plurality of individually encrypted data packets to increase in a data size. In an example, a device monitoring the network may identify a pattern of the plurality of individually encrypted data packets based on the information indicative of the injected data. The monitoring device may determine that a data size of one or more of the plurality of individually encrypted data packets appear in the network according to a particular signal pattern (e.g., the pulse signal according to the one or more attributes) and correlates with the information indicative of the injected data. Thus, the monitoring device may identify the data injected into the network based on the correlation of the information indicative of the injected data with the effect caused to the network by the injected data.

At step 706, one or more characteristics of the network may be determined based on the identification of the data injected into the network. The one or more characteristics of the network may comprise one or more of a network backlog, network congestion, or data packet loss. As an example, the one or more characteristics may be used to determine that one of the data streams of the network is being routed via a device that is experiencing network congestion. A monitoring device may identify this issue and notify the device sending data through the network so that the device may cause the independent data stream to re-route via a second device. As an example, a monitoring device may analyze the network based on identifying the injected data to determine one or more characteristics of the network over a period of time. The monitoring device may determine one or more characteristics of the network during one or more time segments and correlate the one or more characteristics during each time segment of the one or more time segments to determine how the network behaves and varies over time. The one or more time segments may comprise one or more of one or more contiguous time segments, one or more continuous time segments, or one or more discrete time segments.

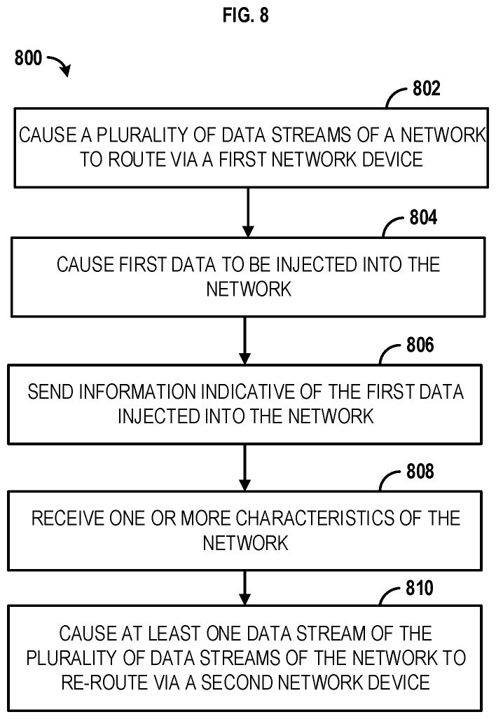

FIG. 8 shows an example method 800 for determining one or more characteristics of a network based on data injected into the network. Method 800 may be implemented by devices 102A-102B, network devices 116A-116D, computing device 104, or any combination thereof. At step 802, a plurality of data streams may be caused to route via a first network device. The plurality of data streams may comprise one or more of first data injected into the network, one or more media streams, one or more video streams, one or more audio streams, or one or more data streams. The network may comprise the plurality of data streams, wherein the plurality of data streams may be associated with a plurality of individually encrypted data packets.

At step 804, first data may be injected into the network. The injected first data may comprise a pulse signal having one or more attributes. The one or more attributes may comprise one or more of a predetermined data size, a predetermined data frequency, a predetermined data pattern, a random data pattern, a predetermined data injection interval, or any combination thereof. For example, the injected first data may comprise unencrypted data. The unencrypted data injected into the network may result in one or more of the plurality of individually encrypted data packets to increase in a data size. In an example, the pattern of the increased data sizes of the one or more individually encrypted data packets may be correlated with information indicative of the injected first data in order to identify the injected first data.

At step 806, information indicative of the injected first data may be sent into the network. The information indicative of the injected first data may be used to identify the first data injected into the network. For example, the information indicative of the injected first data may comprise the one or more attributes of the injected first data. For example, the injection of the first data into the network may cause an effect to the network that may be identified by a device monitoring the network by correlating the effect with the information indicative of the first data. For example, the monitoring device may identify a pattern of the plurality of individually encrypted data packets based on the information indicative of the injected first data. The monitoring device may determine that a data size of one or more of the plurality of individually encrypted data packets appear in the network according to a particular signal pattern (e.g., the pulse signal according to the one or more attributes) and correlates with the information indicative of the injected first data. Thus, the monitoring device may identify the first data injected into the network based on the correlation of the information indicative of the injected first data with the effect caused to the network by the injected first data.

At step 808, one or more characteristics of the network may be received. For example, a monitoring device may be configured to receive the information indicative of the injected first data. The monitoring device may be configured to monitor the network and correlate an effect caused to the network based on the injected first data with the information indicative of the injected first data. For example, the unencrypted data injected into the network may result in one or more of the plurality of individually encrypted data packets to increase in a data size. The monitoring device may determine that a data size of one or more of the plurality of individually encrypted data packets appear in the network according to a particular signal pattern (e.g., the pulse signal according to the one or more attributes) and correlates with the information indicative of the injected first data. The monitoring device may identify the first data injected into the network based on the correlation of the information indicative of the injected first data with the effect caused to the network by the injected first data. Based on the identification of the injected first data, the monitoring device may determine one or more characteristics of the network and send the characteristic data to a device that sent the plurality of data streams. The one or more characteristics may comprise one or more of a network backlog, network congestion, or data packet loss.

At step 810, based on the one or more characteristics at least one of the data streams of the plurality of data steams may be caused to re-route via a second network device. For example, a device that sent the plurality of data streams may determine from the one or more characteristics that the first network device may be experiencing network congestion. The device may then cause the at least one independent data stream to be re-routed via the second network device.

In an example, second data may be injected into the network in order to determine if there any issues with re-routing the at least one data stream via the second network device. For example, after the at least one data stream is re-routed via the second network device, a device that established the network may inject the second data based on the re-routing of the at least one data stream to confirm whether or not the new route, via the second network device, is experiencing any network congestion or data packet loss. The injected second data may comprise a pulse signal having one or more attributes. The one or more attributes may comprise one or more of a predetermined data size, a predetermined data frequency, a predetermined data pattern, a random data pattern, a predetermined data injection interval, or any combination thereof. For example, the injected second data may comprise unencrypted data. The unencrypted data injected into the network may result in one or more of the plurality of individually encrypted data packets to increase in a data size. In an example, the pattern of the increased data sizes of the one or more individually encrypted data packets may be correlated with information indicative of the injected second data in order to identify the injected second data.

The information indicative of the injected second data may be sent. For example, the information indicative of the injected second data may comprise the one or more attributes of the injected second data. For example, the injection of the second data into the network may cause an effect to the network that may be identified by a device monitoring the network by correlating the effect with the information indicative of the second data. For example, the monitoring device may identify a pattern of the plurality of individually encrypted data packets based on the information indicative of the injected second data. The monitoring device may determine that a data size of one or more of the plurality of individually encrypted data packets appear in the network according to a particular signal pattern (e.g., the pulse signal according to the one or more attributes) and correlates with the information indicative of the injected second data. Thus, the monitoring device may identify the second data injected into the network based on the correlation of the information indicative of the injected second data with the effect caused to the network by the injected first data.

One or more characteristics of the network associated with the at least one data stream being re-routed via the second network device may be received. For example, a monitoring device may receive the information indicative of the injected second data. The monitor device may correlate an effect caused to the network based on the injected second data with the information indicative of the injected second data. For example, the unencrypted data injected into the network may result in one or more of the plurality of individually encrypted data packets to increase in a data size. The monitoring device may determine that a data size of one or more of the plurality of individually encrypted data packets appear in the network according to a particular signal pattern (e.g., the pulse signal according to the one or more attributes) and correlates with the information indicative of the injected second data. The monitoring device may identify the second data injected into the network based on the correlation of the information indicative of the injected second data with the effect caused to the network by the injected second data. Based on the identifying the injected second data, the monitoring device may determine one or more characteristics of the network and send the characteristic data to a device that sent the plurality of data streams. As an example, the one or more characteristics may indicate, or confirm, whether or not the new route, via the second network device, is experiencing any network congestion or data packet loss.

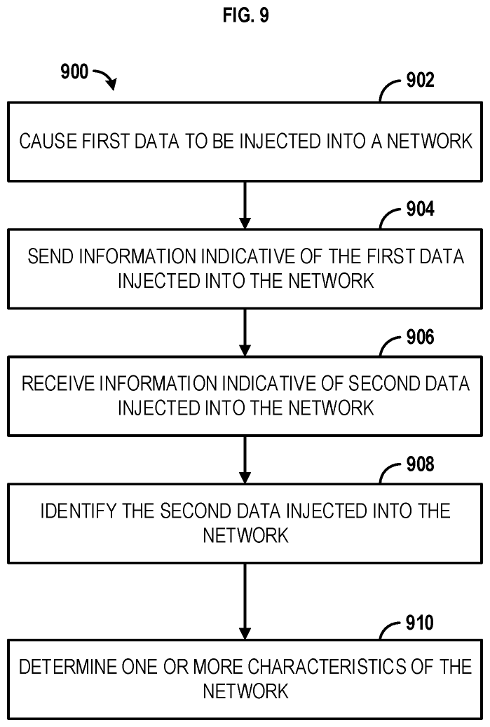

FIG. 9 shows an example method 900 for determining one or more characteristics of a network based on data injected into the network. Method 900 may be implemented by devices 102A-102B, network devices 116A-116D, computing device 104, or any combination thereof. At step 902, first data may be injected into a network. The network may comprise a plurality of data streams, wherein the plurality of data streams may be associated with a plurality of individually encrypted data packets. The injected first data may comprise a pulse signal having one or more attributes. The one or more attributes may comprise one or more of a predetermined data size, a predetermined data frequency, a predetermined data pattern, a random data pattern, a predetermined data injection interval, or any combination thereof. For example, the injected first data may comprise unencrypted data. The unencrypted data injected into the network may result in one or more of the plurality of individually encrypted data packets to increase in a data size. In an example, the pattern of the increased data sizes of the one or more individually encrypted data packets may be correlated with information indicative of the injected first data in order to identify the injected first data.

At step 904, information indicative of the injected first data may be sent. The information indicative of the injected first data may be used to identify the first data injected into the network. For example, the information indicative of the injected first data may comprise the one or more attributes of the injected first data. For example, the injection of the first data into the network may cause an effect to the network that may be identified by a device monitoring the network by correlating the effect with the information indicative of the first data. For example, the monitoring device may identify a pattern of the plurality of individually encrypted data packets based on the information indicative of the injected first data. The monitoring device may determine that a data size of one or more of the plurality of individually encrypted data packets appear in the network according to a particular signal pattern (e.g., the pulse signal according to the one or more attributes) and correlates with the information indicative of the injected first data. Thus, the monitoring device may identify the first data injected into the network based on the correlation of the information indicative of the injected first data with the effect caused to the network by the injected first data.

At step 906, information indicative of second data injected into the network may be received. The information indicative of the injected second data may comprise one or more attributes (e.g., data size, data frequency, data pattern, and/or data injection interval) of the injected second data. In an example, a monitoring device may be configured to receive the information indicative of the injected first data. The monitoring device may be configured to monitor the network and correlate an effect caused to the network based on the injected first data with the information indicative of the injected first data. For example, the unencrypted data injected into the network may result in one or more of the plurality of individually encrypted data packets to increase in a data size. The monitoring device may determine that a data size of one or more of the plurality of individually encrypted data packets appear in the network according to a particular signal pattern (e.g., the pulse signal according to the one or more attributes) and correlates with the information indicative of the injected first data. The monitoring device may identify the first data injected into the network based on the correlation of the information indicative of the injected first data with the effect caused to the network by the injected first data. Based on the identification of the injected first data, the monitoring device may determine one or more characteristics of the network. Based on the one or more characteristics, the monitoring device may inject second data into the network and send information indicative of second data injected into the network to a device that may have injected the first data into the network. For example, two devices may bi-directionally communicate with each other via the network in order to communicate one or more characteristics of the network, such as, for example, network backlog, network congestion, or data packet loss.

At step 908, the injected second data may be identified based on a correlation of the information indicative of the injected second data and an effect caused to the network by the injected second data. For example, the initial data injected into the network may comprise unencrypted data. The unencrypted data injected into the network may result in one or more of the plurality of individually encrypted data packets to increase in a data size. In an example, a device monitoring the network may identify a pattern of the plurality of individually encrypted data packets based on the information indicative of the injected data. The monitoring device may determine that a data size of one or more of the plurality of individually encrypted data packets appear in the network according to a particular signal pattern (e.g., the pulse signal according to the one or more attributes) and correlates with the information indicative of the injected second data. Thus, the monitoring device may identify the second data injected into the network based on the correlation of the information indicative of the injected second data with the effect caused to the network by the injected second data.

At step 910, one or more characteristics of the network may be determined based on the identification of the second data injected into the network. The one or more characteristics of the network may comprise one or more of a network backlog, network congestion, or data packet loss. In an example, the one or more characteristics may be used to determine that one of the data streams of the plurality of data streams is being routed via a device that is experiencing network congestion. A monitoring device may identify this issue and notify the device sending data through the network so that the device may cause the data stream to re-route via a second device.

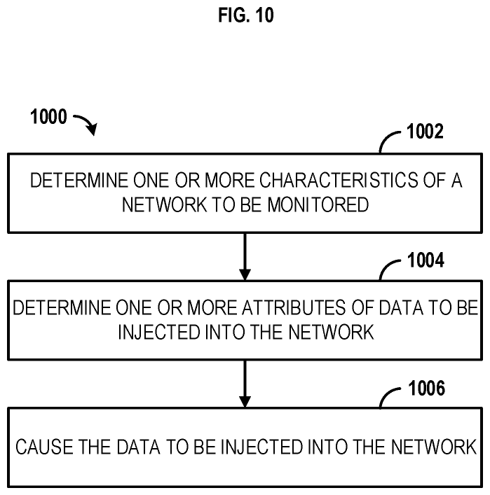

FIG. 10 shows an example method 1000 for defining the data to be injected into a network based on one or more characteristics of the network to be monitored. Method 1000 may be implemented by devices 102A-102B, network devices 116A-116D, computing device 104, or any combination thereof. At step 1002, one or more characteristics of a network to be monitored may be determined. The one or more characteristics of the network to be monitored may comprise one or more of a network backlog, network congestion, or data packet loss. The network may comprise a plurality of data streams associated with a plurality of individually encrypted data packets. The plurality of data streams may comprise one or more of injected data, one or more media streams, one or more video streams, one or more audio streams, or one or more data streams.

A step 1004, one or more attributes of data to be injected into injected into the network may be determined based on the one or more characteristics of the network to be monitored. The one or more attributes may comprise one or more of a predetermined data size, a predetermined data frequency, or a predetermined data injection interval. As an example, the data to be injected into the network may be defined based on the one or more characteristics of the network to be monitored. The injected data may be defined in a manner to improve the accuracy of determining the one or more characteristics to be monitored. For example, the injected data may be defined as a square wave (e.g., pulse signal) injected at a specified frequency. The network may be monitored at an interval every t times associated with the frequency. The frequency may not comprise an even multiple of t, and thus, the injected data may span multiple collection intervals. The result is that the injected data, over time, may be distinctly recognizable by a device monitoring the network.

At step 1006, the data may be injected into the network. The data injected into the network may be defined according to the one or more attributes. For example, the data may comprise a pulse signal. In an example, information indicative of the injected data may be sent. The information indicative of the injected data may comprise the one or more attributes of the injected data. The information indicative of the injected data may be used by a monitoring device to identify the data injected into the network. For example, the injection of the data into the network may cause an effect to the network that may be identified by a device monitoring the network by correlating the effect with the information indicative of the data. For example, the monitoring device may identify a pattern of the plurality of individually encrypted data packets based on the information indicative of the injected data. The monitoring device may determine that a data size of one or more of the plurality of individually encrypted data packets appear in the network according to a particular signal pattern (e.g., the pulse signal according to the one or more attributes) and correlates with the information indicative of the injected first data. Thus, the monitoring device may identify the data injected into the network based on the correlation of the information indicative of the injected data with the effect caused to the network by the injected data.

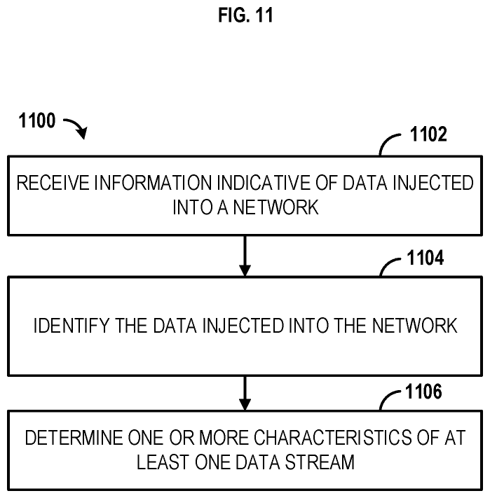

FIG. 11 shows an example method 1100 for determining one or more characteristics of a network based on data injected into the network. Method 1100 may be implemented by devices 102A-102B, network devices 116A-116D, computing device 104, or any combination thereof. At step 1102, information indicative of data injected into the network may be received. The injected data may comprise a pulse signal having one or more attributes. The one or more attributes may comprise one or more of a predetermined data size, a predetermined data frequency, a predetermined data pattern, a random data pattern, a predetermined data injection interval, or any combination thereof. The information indicative of the injected data may comprise the one or more attributes of the injected data. The network may comprise a plurality of data streams associated with a plurality of individually encrypted data packets. The plurality of data streams may comprise one or more of the injected data, one or more media streams, one or more video streams, one or more audio streams, or one or more data streams.

At step 1104, the injected data may be identified based on a correlation of the information indicative of the injected data with an effect caused to the network by the injected data. For example, the initial data injected into the network may comprise unencrypted data. The unencrypted data injected into the network may result in one or more of the plurality of individually encrypted data packets to increase in a data size. In an example, a device monitoring the network may identify a pattern of the plurality of individually encrypted data packets based on the information indicative of the injected data. The monitoring device may determine that a data size of one or more of the plurality of individually encrypted data packets appear in the network according to a particular signal pattern (e.g., the pulse signal according to the one or more attributes) and correlates with the information indicative of the injected data. Thus, the monitoring device may identify the data injected into the network based on the correlation of the information indicative of the injected data with the effect caused to the network by the injected data.

At step 1106, one or more characteristics of at least one data stream of the plurality of data streams may be determined based on the identification of the data injected into the network. The one or more characteristics of the at least one data stream may comprise one or more of a bit rate of the at least one data stream, or a bandwidth requirement of the at least one data stream. In an example, a monitoring device may compare the injected data to the data of the network. For example, the monitoring device may “subtract” the signature of the injected data from the collected telemetry of the network (e.g., the total amount of data of the network, or network connection) to determine the one or more characteristics of the at least one data stream.

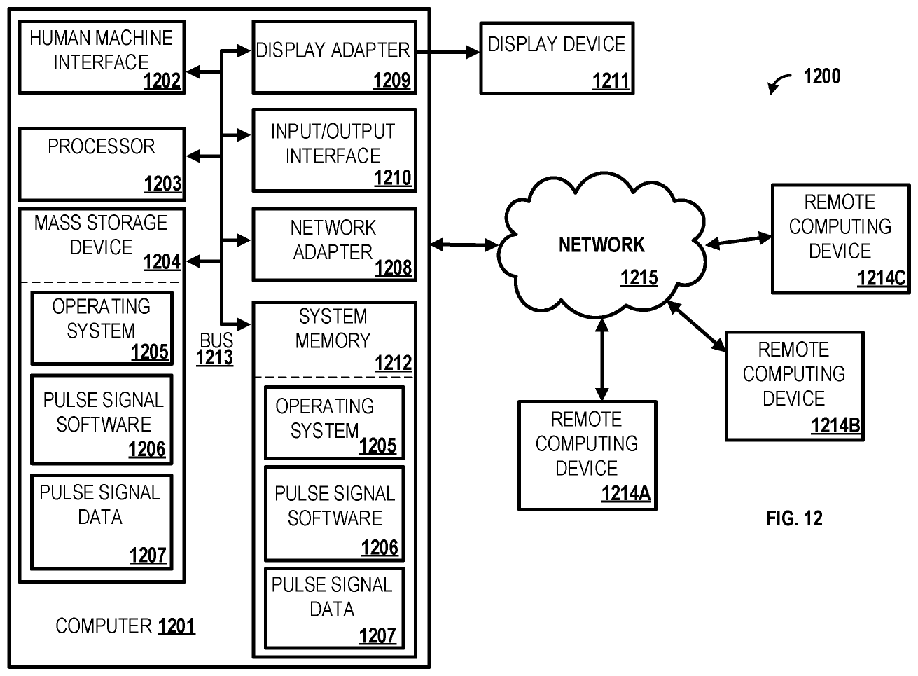

The methods and systems may be implemented on a computer 1201 as illustrated in FIG. 12 and described below. By way of example, computing device 104, devices 102A-102B, and/or one or more of the network devices 116A-116D of FIG. 1 may be a computer 1201 as illustrated in FIG. 12. Similarly, the methods and systems disclosed can utilize one or more computers to perform one or more functions in one or more locations. FIG. 12 is a block diagram illustrating an example operating environment 1200 for performing the disclosed methods. This operating environment 1200 is only an example of an operating environment and is not intended to suggest any limitation as to the scope of use or functionality of operating environment architecture. Neither should the operating environment 1200 be interpreted as having any dependency or requirement relating to any one or combination of components illustrated in the operating environment 1200.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 1201. The computer 1201 can comprise one or more components, such as one or more processors 1203, a system memory 1212, and a bus 1213 that couples various components of the computer 1201 comprising the one or more processors 1203 to the system memory 1212. The system can utilize parallel computing.

The bus 1213 can comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1213, and all buses specified in this description can also be implemented over a wired or wireless network connection and one or more of the components of the computer 1201, such as the one or more processors 1203, a mass storage device 1204, an operating system 1205, pulse signal software 1206, pulse signal data 1207, a network adapter 1208, the system memory 1212, an

Input/Output Interface 1210, a display adapter 1209, a display device 1211, and a human machine interface 1202, can be contained within one or more remote computing devices 1214A-1214C at physically separate locations, connected through buses of this form, in effect implementing a fully distributed system.

The computer 1201 typically comprises a variety of computer readable media. For example, computer readable media may be any available media that is accessible by the computer 1201 and comprises, for example and not meant to be limiting, both volatile and non-volatile media, removable and non-removable media. The system memory 1212 can comprise computer readable media in the form of volatile memory, such as random access memory (RAM), and/or non-volatile memory, such as read only memory (ROM). The system memory 1212 typically can comprise data such as the pulse signal data 1207 and/or program modules such as the operating system 1205 and the pulse signal software 1206 that are accessible to and/or are operated on by the one or more processors 1203.

The computer 1201 may also comprise other removable/non-removable, volatile/non-volatile computer storage media. The mass storage device 1204 can provide non-volatile storage of computer code, computer readable instructions, data structures, program modules, and other data for the computer 1201. For example, the mass storage device 1204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1204, such as, by way of example, the operating system 1205 and the pulse signal software 1206. One or more of the operating system 1205 and the pulse signal software 1206 (or some combination thereof) can comprise elements of the programming and the pulse signal software 1206. The pulse signal data 1207 can also be stored on the mass storage device 1204. The pulse signal data 1207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1215.

The user may enter commands and information into the computer 1201 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1203 via the human machine interface 1202 that is coupled to the bus 1213, but can be connected by other interface and bus structures, such as a parallel port, game port, an IEEE 1394 Port (also known as a Firewire port), a serial port, a network adapter 1208, and/or a universal serial bus (USB).

In yet another aspect, the display device 1211 can also be connected to the bus 1213 via an interface, such as the display adapter 1209. It is contemplated that the computer 1201 can have more than one display adapter 1209 and the computer 1201 can have more than one display device 1211. For example, the display device 1211 can be a monitor, an LCD (Liquid Crystal Display), light emitting diode (LED) display, television, smart lens, smart glass, and/or a projector. In addition to the display device 1211, other output peripheral devices can comprise components such as speakers (not shown) and a printer (not shown) which can be connected to the computer 1201 via an Input/Output Interface 1210. Any step and/or result of the methods can be output in any form to an output device. Such output can be any form of visual representation, comprising, but not limited to, textual, graphical, animation, audio, tactile, and the like. The display device 1211 and the computer 1201 can be part of one device, or separate devices.

The computer 1201 can operate in a networked environment using logical connections to one or more remote computing devices 1214A-1214C. By way of example, a remote computing device 1214A-1214C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1201 and a remote computing device 1214A-1214C can be made via a network 1215, such as a local area network (LAN) and/or a general wide area network (WAN). Such network connections can be through the network adapter 1208. The network adapter 1208 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1205 are illustrated herein as discrete blocks, although it is recognized that such programs and components can reside at various times in different storage components of the computing device 1201, and are executed by the one or more processors 1203 of the computer 1201. An implementation of the pulse signal software 1206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. In an example, computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a network device, information indicative of data injected into a network, wherein the network comprises a plurality of data streams associated with a plurality of individually encrypted data packets;
identifying, based on a correlation of the information indicative of the data injected into the network with an effect caused to the network, the data injected into the network, wherein the effect is caused to the network by the data injected into the network; and
determining, based on the identification of the data injected into the network, one or more characteristics of the network.

2. The method of claim 1, wherein the information indicative of the data injected into the network comprises one or more attributes of the injected data.

3. The method of claim 1, wherein the injected data is a pulse signal comprising one or more attributes comprising one or more of a predetermined data size, a predetermined data frequency, a predetermined data pattern, a random data pattern, or a predetermined data injection interval.

4. The method of claim 1, wherein the plurality of data streams comprises one or more of: the injected data, one or more media streams, one or more video streams, one or more audio streams, or one or more data streams.

5. The method of claim 1, wherein the effect caused to the network comprises an increase in a data size of one or more data packets of the plurality of individually encrypted data packets.

6. The method of claim 1, wherein the one or more characteristics comprise one or more of a network backlog, network congestion, or data packet loss.

7. The method of claim 1, further comprising determining the one or more characteristics of the network during one or more time segments.

8. A method comprising:
causing, by a computing device, a plurality of data streams of a network to route via a first network device, wherein the plurality of data streams are associated with a plurality of individually encrypted data packets;
causing first data to be injected into the network;
sending information indicative of the first data injected into the network;
receiving one or more characteristics of the network, wherein the one or more characteristics of the network are determined based on a correlation of the information indicative of the first data injected into the network with an effect caused to the network by the injected first data; and
causing, based on the one or more characteristics, at least one data stream of the plurality of data streams of the network to re-route via a second network device.

9. The method of claim 8, wherein the plurality of data streams comprise one or more of: the injected first data, one or more media streams, one or more video streams, one or more audio streams, or one or more data streams.

10. The method of claim 8, wherein the injected first data is a pulse signal comprising one or more attributes comprising one or more of a predetermined data size, a predetermined data frequency, a predetermined data pattern, a random data pattern, or a predetermined data injection interval.

11. The method of claim 8, wherein the information indicative of the first data injected into the network comprises one or more attributes of the injected first data.

12. The method of claim 8, wherein the one or more characteristics comprise one or more of a network backlog, network congestion, or data packet loss.

13. The method of claim 8, wherein the effect caused to the network comprises an increase in a data size of one or more data packets of the plurality of individually encrypted data packets.

14. The method of claim 8, further comprising:
causing, based on the at least one data stream re-routing via the second network device, second data to be injected into the network;
sending information indicative of the second data injected into the network; and
receiving one or more characteristics of the network associated with the at least one data stream re-routing via the second network device.

15. The method of claim 14, further comprising wherein the one or more characteristics associated with the at least one data stream re-routing via the second network device are determined based on a correlation of the information indicative of the second data injected into the network with an effect caused to the network by the injected second data.

16. A method comprising:
causing, by a first device, first data to be injected into a network, wherein the network comprises a plurality of data streams associated with a plurality of individually encrypted data packets;
sending information indicative of the first data injected into the network;
receiving, from a second device, information indicative of second data injected into the network, wherein the second device sends the information indicative of the second data injected into the network based on a correlation of the information indicative of the first data injected into the network with an effect caused to the network by the injected first data;
identifying, based on a correlation of the information indicative of the second data injected into the network with an effect caused to the network by the injected second data, the second data injected into the network; and
determining, based on the identification of the second data injected into the network, one or more characteristics of the network.

17. The method of claim 16, wherein at least one of the injected first data or the injected second data is a pulse signal comprising one or more attributes comprising one or more of a predetermined data size, a predetermined data frequency, a predetermined data pattern, a random data pattern, or a predetermined data injection interval.

18. The method of claim 16, wherein the plurality of data streams comprises one or more of: the injected first data, the injected second data, one or more media streams, one or more video streams, one or more audio streams, or one or more data streams.

19. The method of claim 16, wherein the information indicative of the first data injected into the network comprises one or more attributes of the injected first data.

20. The method of claim 16, wherein at least one of the effect caused to the network by the injected first data or the effect caused to the network by the injected second data comprises an increase in a data size of one or more data packets of the plurality of individually encrypted data packets.
